(19) United States
(12) Patent Application Publication
(10) Pub. No.: US 2024/0242492 A1
(43) Pub. Date: Jul. 18, 2024

(54) METHOD AND ELECTRONIC DEVICE WITH REPRESENTATION LEARNING

(71) Applicant: Samsung Electronics Co., Ltd., Suwon-si (KR)

(72) Inventors: Sangkyu PARK, Suwon-si (KR); Keunseo KIM, Suwon-si (KR)

(73) Assignee: Samsung Electronics Co., Ltd., Suwon-si (KR)

(21) Appl. No.: 18/407,957

(22) Filed: Jan. 9, 2024

(30) Foreign Application Priority Data
Jan. 12, 2023 (KR) 10-2023-0004944

(51) Int. Cl. G06V 10/82; G06V 10/77; G06V 10/771; G06V 10/776

(52) U.S. Cl. CPC G06V 10/82; G06V 10/771; G06V 10/7715; G06V 10/776

(57) ABSTRACT

A method and electronic device are provided herein. A processor-implemented method may include training a neural network through representation learning using, as training data, a plurality of signal images, a respective metadata mapped to each of the plurality of signal images, and a respective temporary classified label of each of the plurality of signal images, extracting latent features for each of the plurality of signal images using the trained neural network, and generating a feature map representing the plurality of signal images based on respective differences between the extracted latent features, and correcting label information, for a signal image and for a corresponding temporary classification label in the respective temporary classified labels, to have corrected classification information, including determining that the corresponding temporary classification label of the signal image is mislabeled using the generated feature map.

### CROSS-REFERENCE TO RELATED APPLICATIONS

This application claims priority under 35 USC § 119(a) to Korean Patent Application No. 10-2023-0004944 filed on Jan. 12, 2023, in the Korean Intellectual Property Office, the entire disclosure of which is incorporated herein by reference for all purposes.

### BACKGROUND

### 1. Field

The following description relates to a method and electronic device with representation learning.

### 2. Description of Related Art

In a semiconductor facility, tens to hundreds of sensors are used, and sensor data obtained by the sensors may be stored at equal time intervals while wafers are input and output to/from a fabrication system (or internal fabrication stages within the fabrication system). Based on a change in sensor values measured by the sensors, an occurred abnormality in a semiconductor process stage may be detected. There may be dozens to tens of thousands of sensor data obtained by the sensors in the semiconductor facility according to a process stage, of which most sensor data may be normal data and an extremely small portion of the sensor data may be classified as abnormal data. A typical feature map analysis such as a typical t-distributed stochastic neighbor embedding (t-SNE) machine learning model may not readily define or differentiate normal data from abnormal data, or define a boundary between the normal data and the abnormal data, in such a class imbalance environment where the number of abnormal data may be extremely small compared to the normal data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes training a neural network through representation learning using, as training data, a plurality of signal images, a respective metadata mapped to each of the plurality of signal images, and a respective temporary classified label of each of the plurality of signal images, extracting latent features for each of the plurality of signal images using the trained neural network, and generating a feature map representing the plurality of signal images based on respective differences between the extracted latent features, and correcting label information, for a signal image and for a corresponding temporary classification label in the respective temporary classified labels, to have corrected classification information, including determining that the corresponding temporary classification label of the signal image is mislabeled using the generated feature map.

The correcting of the label information may include updating the corresponding temporary classification label, in the respective temporary classified labels, to be the corrected classification information, and the training of the neural network may include training the neural network using, as corresponding training data, the plurality of signal images, the respective metadata corresponding to the plurality of signal images, and updated label information that correspond to the respective temporary classification labels with the updated corresponding temporary classification label.

The determining that the corresponding temporary classification label of the signal image is mislabeled may include, with the feature map including a target point corresponding to a target signal image which has been classified as a first label, selecting the target signal image corresponding to the signal image to determine the mislabeled corresponding temporary classification label based on multiple signal images, corresponding to a respective first number of different points in the generated feature map within a first proximity to the target point, all having been classified as a second label different from the first label.

The determining that the corresponding temporary classification label of the signal image is mislabeled may include determining the mislabeled corresponding temporary classification label by selecting the signal image from among two signal images, of the plurality of signal images, that have been respectively classified as different labels and that may be represented as respective points in the feature map having a same position, including selecting the signal image that is not classified as a third label, and the third label may be a label corresponding to a direction toward the respective points with respect to a boundary line disposed around the same position.

The neural network may include an encoder configured to generate extracted data in response to a corresponding signal image of the plurality of signal images being input to the encoder, a classification header configured to output a classified label of the corresponding signal image, and a metadata header configured to output metadata mapped to the corresponding signal image.

The neural network may further include a decoder configured to restore the corresponding signal image using extracted data, and the training of the neural network may include, for each of the plurality of signal images, training the encoder, the decoder, the classification header, and the metadata header based on a representation loss with respect to the corresponding signal image and the restored corresponding signal image, a classification loss with respect to a training classification label and an output label of the classification header that may be dependent on an operation of the encoder with respect to the corresponding signal image, and a metadata loss with respect to a training metadata and an output of the metadata header that may be dependent on the operation of the encoder.

The neural network may further include a decoder configured to restore the corresponding signal image using the extracted data, and the training of the neural network may include performing a first training of the encoder and the decoder, and performing a second training using the first trained encoder, the classification header, and the metadata header.

The performing of the first training may include generating first temporary output data by a decoder header of the decoder based on the extracted data, calculating a representation loss based on the calculated first temporary output data and the corresponding signal image, and performing the first training of only the encoder and the decoder based on the calculated representation loss.

The performing of the first training may include performing the first training until a corresponding calculated representation loss decreases to be less than a threshold loss, with the plurality of signal images being used as training data for the corresponding signal image.

The performing of the second training may include generating, dependent on another corresponding signal image being provided to the first trained encoder, second temporary output data by the classification header and third temporary output data by the metadata header, respectively, generating a classification loss based on the second temporary output data and a previously classified label of the other corresponding signal image, and a metadata loss based on the third temporary output data and previously mapped metadata of the other corresponding signal image, and performing the second training based on a total loss comprising the calculated representation loss, the calculated classification loss, and the calculated metadata loss.

The performing of the second training may include ending the second training upon a first clustering score for first metadata calculated from the generated feature map exceeding a first threshold score and a second clustering score for a label calculated from the generated feature map exceeding a second threshold score, while the second training may be being performed using the plurality of signal images as training data for the other corresponding signal image.

The performing of the second training may include, for each corresponding point of a plurality of points corresponding to the plurality of signal images in the generated feature map, assigning a respective first score to the corresponding point that corresponds to a corresponding first signal image based on whether multiple signal images corresponding to a second number of different points, within a preset proximity to the corresponding point, have each been classified as having a same label as the corresponding first signal image, and calculating, as the first clustering score, an average of the respective first scores.

The performing of the second training may include, for each corresponding point of a plurality of points in the generated feature map corresponding to the plurality of signal images, assigning a respective second score to the corresponding point, which corresponds to a corresponding second signal image, that has a third number of different points within a preset proximity to the corresponding point that all have a determined similar metadata to metadata of the corresponding second signal image, and calculating, as the second clustering score, an average of the respective second scores.

The method may further include labeling classifications of each of a plurality of signal images to generate the respective temporary classified labels, and training an encoder to perform the extraction of the latent features, where the training of the neural network may include training a classification header and a metadata header of the neural network based on results on the trained encoder, a classification loss, and a metadata loss, with each epoch of the training of the neural network including a corresponding performance of the correcting of the label information, and, when a final epoch of the plurality of epochs is determined to be the final epoch that completes the training of the classification header and the metadata header, one or more final classified abnormal signal images may be identified by corresponding final outputs of the classification header in the final epoch and by a corresponding final performance of the correcting of the label information.

In one general aspect, an electronic device, includes a processor configured to perform labeling on each of a plurality of signal images and classify each of the plurality of signal images into respective temporary classified labels, train a neural network through representation learning using, as training data, a plurality of signal images, a respective metadata mapped to each of the plurality of signal images, and the respective temporary classified label of each of the plurality of signal images, extract latent features for each of the plurality of signal images using the trained neural network, and generate a feature map representing the plurality of signal images based on respective differences between the extracted latent features, and correct label information, for a signal image and for a corresponding temporary classification label in the respective temporary classified labels, to have corrected classification information, including determining that the corresponding temporary classification label of the signal image is mislabeled using the generated feature map.

For the correcting of the label information, the processor may be configured to update the corresponding temporary classification label, in the respective temporary classified labels, to be the corrected classification information, and, for the training of the neural network, the processor may be configured to train the neural network using, as corresponding training data, the plurality of signal images, the respective metadata corresponding to the plurality of signal images, and updated label information that correspond to the respective temporary classification labels with the updated corresponding temporary classification label.

For the determining that the corresponding temporary classification label of the signal image is mislabeled, the processor may be configured to, with the feature map including a target point corresponding to a target signal image which has been classified as a first label, select the target signal image corresponding to the signal image to determine the mislabeled corresponding temporary classification label based on multiple signal images, corresponding to a respective first number of different points in the generated feature map within a first proximity to the target point, all having been classified as a second label different from the first label.

The neural network may include an encoder configured to generate extracted data in response to a corresponding signal image of the plurality of signal images being input to the encoder, a classification header configured to output a classified label of the corresponding signal image, and a metadata header configured to output metadata mapped to the corresponding signal image.

The neural network may further include a decoder configured to restore the corresponding signal image using the extracted data, and the processor may be configured to train the encoder and the decoder, and for the training of the neural network, using the first trained encoder, train the classification header and the metadata header.

The processor may be configured to generate first temporary output data by a decoder header of the decoder based on the extracted data, calculate a representation loss based on the calculated first temporary output data and the corresponding signal image, and perform the first training of only the encoder and the decoder based on the calculated representation loss.

For the training of the neural network, the processor may be configured to generate, dependent on another corresponding signal image being provided to the first trained encoder, second temporary output data by the classification header and third temporary output data by the metadata header, respectively, generate a classification loss based on the second temporary output data and a previously classified label of the other corresponding signal image, and a metadata loss based on the third temporary output data and previously mapped metadata of the other corresponding signal image, and train the neural network based on a total loss comprising the calculated representation loss, the calculated classification loss, and the calculated metadata loss.

For the training of the neural network, the processor may be configured to end the training of the neural network upon a first clustering score for first metadata calculated from the generated feature map exceeding a first threshold score and a second clustering score for a label calculated from the generated feature map exceeding a second threshold score, while the training of the neural network is being performed using the plurality of signal images as training data for the other corresponding signal image.

Other features and aspects will be apparent from the following detailed description, the drawings, and the claims.

### BRIEF DESCRIPTION OF THE DRAWINGS

FIG. 1 illustrates an example electronic device and flow diagram, in accordance with one or more embodiments.

FIG. 2 illustrates an example signal image generated by an electronic device, in accordance with one or more embodiments.

FIG. 3 illustrates an example of identifying, by an electronic device, a mislabeled signal image from a feature map, in accordance with one or more embodiments.

FIG. 4 illustrates an example neural network configured to perform representation learning, in accordance with one or more embodiments.

FIG. 5 illustrates an example method of training a neural network by an electronic device, in accordance with one or more embodiments.

FIG. 6 illustrates an example feature map generated by an electronic device using a trained neural network, in accordance with one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for operations necessarily occurring in a certain order. As another example, the sequences of and/or within operations may be performed in parallel, except for at least a portion of sequences of and/or within operations necessarily occurring in an order (e.g., a certain order). Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning, e.g., the phrasing “in one example” has a same meaning as “in one embodiment” and “one or more examples” has a same meaning as “in one or more embodiments.”

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, or layers intervening therebetween. When a component, element, or layer is described as being “directly on”, “directly connected to,” “directly coupled to,” or “directly joined to” another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

As non-limiting example, one or more embodiments may include a semiconductor facility or system, including tens to hundreds of sensors, and the collecting of such sensor data (e.g., at equal time intervals, as a non-limiting example) while wafers (or chips) are input and output to/from the fabrication system (or to/from/during internal fabrication stages within the fabrication system). Abnormalities in any of these semiconductor processes (e.g., at various such internal fabrication stages) may be detected in the sensed data. Non-limiting examples may include dozens to tens of thousands of sensors and sensor data in such a semiconductor facility or system. While examples may be provided with respect to such an example wafer fabrication, examples are not limited thereto and examples include implementations in other fields where abnormalities are detected for through such sensor data.

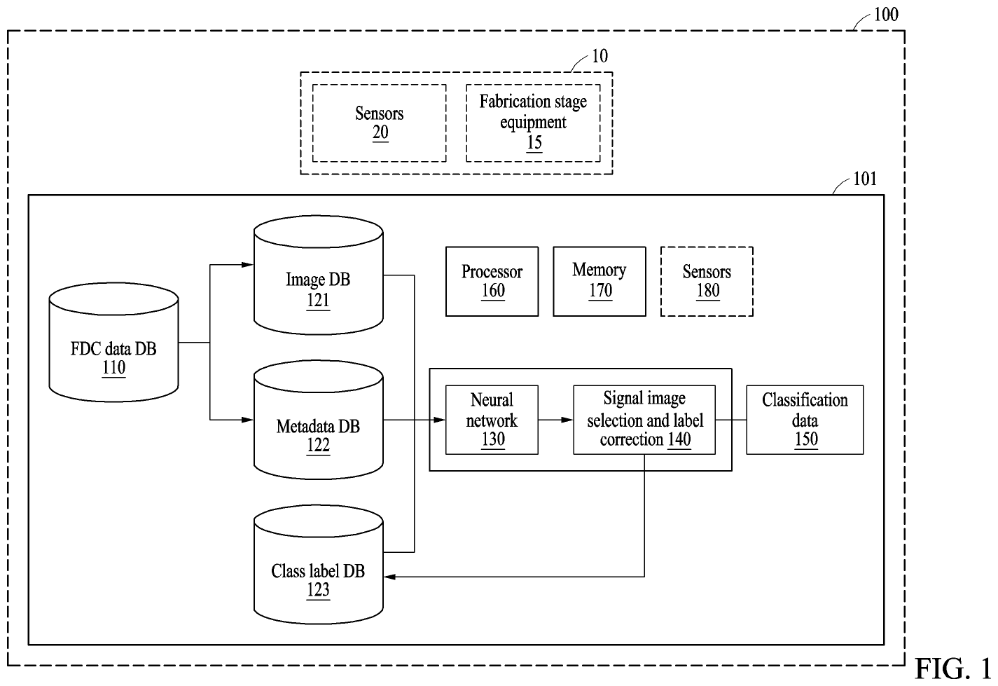

FIG. 1 illustrates an example electronic device and flow diagram, in accordance with one or more embodiments.

In an example, an electronic device 101 may generate signal images and label the generated signal images. The electronic device 101 may label each of the signal images as one of a plurality of labels. The electronic device 101 may generate the plurality of labels. For example, the electronic device 101 may generate two labels (e.g., a label for normal data (hereinafter a “normal label”) and a label for abnormal data (hereinafter an “abnormal label”)) and classify each of the signal images as one of the labels. However, the number of labels into which the signal images are classified is not limited to two, and the electronic device 101 may generate three or more labels and classify the signal images with respect to the three or more labels. Hereinafter, for the convenience of description and a non-limiting example, the following description will focus on an example of classifying, by the electronic device 101, each signal image into one of the normal (data) label and the abnormal (data) label.

In an example, the electronic device 101 may train a neural network through representation learning to label the signal images. For example, the electronic device 101 may accurately label the signal images through representation learning in a class imbalance environment. The class imbalance environment may refer to an environment in which the number of data that would be accurately classified to have the abnormal label may be extremely smaller compared to the number of data that would be accurately classified to have the normal label.

In an example, the electronic device 101 in a non-limiting fabrication system 100 may include a fault detection and classification (FDC) data database (DB) 110. The FDC data DB 110 may include FDC data. A processor 160 of the electronic device 101 may receive raw data (e.g., from sensors 180 and/or from one or more fabrication stage/stations 10 of the fabrication system 100). Each fabrication stage/station 10 may have one or sensors 20 that monitor and sense fabrication being performed (e.g., on a wafer) by a corresponding fabrication stage equipment 15 and/or that generate sensed data of a corresponding positioned pre- or post-fabricated item (e.g., the wafer) at a corresponding fabrication stage equipment 15, and store that raw data in the FDC DB 110. In an example, the raw data may be stored directly to FDC DB 110 without operation of the processor 160.

In an example, the processor 160 may obtain/receive the stored raw data from the FDC DB 110, and extract respective sensor data from the obtained/received raw data. The processor 160 may generate a plurality of signal images from the extracted sensor data and store the generated plurality of signal images in an image DB 121. The processor 160 may generate a signal image that represents a signal graph indicating measurement values of a sensor over time.

In an example, the processor 160 may be configured to execute computer/processor readable and/or executable instructions stored in the memory 170, such that when the processor 160 executes the instructions, the processor may thereby be configured to implement any one or any combination of two or more (or all) of the operations and/or methods described herein.

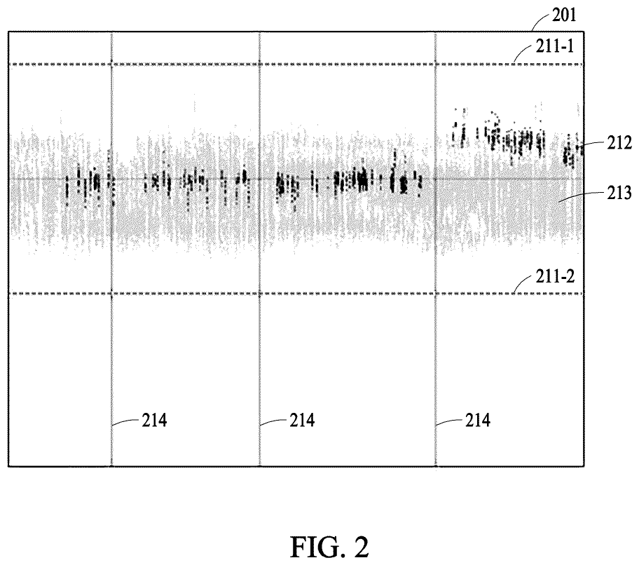

FIG. 2 illustrates an example signal image generated by an electronic device, in accordance with one or more embodiments. In an example, a processor of an electronic device (e.g., the processor 160 of FIG. 1) may generate a signal image that represents a signal graph indicating respective measurement values of a sensor over time. In an example, the processor may generate the signal image 201 representing a plurality of signal graphs of time-based measurement values of respective sensors. For example, the processor may generate a signal graph indicating a measurement value of a sensor over time for each of a plurality of sensors, and generate the signal image 201 using the generated plurality of signal graphs.

In an example, the processor may generate the signal image 201 to represent additional information in addition to the plurality of signal graphs in the signal image 201. The additional information may refer to information to which reference may be made to perform labeling on the signal image. The additional information may include, for example, information on an upper specification limit (USL)/lower specification limit (LSL), information on a current signal, and information on a corresponding preventive maintenance (pm) signal. For example, the processor may generate a USL 211-1 and an LSL 211-2, and mark the generated USL 211-1 and the generated LSL 211-2 in the signal image 201. The USL line 211-1 may be generated to be greater than all measurement values of the sensors in the plurality of signal graphs, and the LSL line 211-2 may be generated to be lower than all the measurement values of the sensors in the plurality of signal graphs. That is, all the measurement values of the sensors in the plurality of signal graphs included in the signal image 201 may be present between the USL line 211-1 and the LSL line 211-2. In an example, the processor may distinguishably mark one signal graph 212 corresponding to a current signal in the signal image 201 from other signal graphs 213. In an example, the processor may generate a signal graph 214 corresponding to the corresponding preventive maintenance (pm) signal and may mark the signal graph 214 corresponding to the pm signal in the signal image 201. The signal graph 214 corresponding to the pm signal may also indicate a time at which pm occurs. Even though a plurality of signal images generated by a same virtual metrology (VM) item may have similar patterns, the plurality of signal images may be labeled differently for respective different times at which a pm signal is generated in each signal image, and thus the signal graph 214 corresponding to the pm signal may be represented in the signal image 201, and a corresponding pm signal of another signal image may be represented in that other signal image.

Referring back to FIG. 1, the processor 160 may extract metadata associated with process information from the raw data received from the FDC data DB 110 and store the extracted metadata in a metadata DB 122. For example, the processor 160 may generate a signal image and extract metadata associated with the generated signal image. The processor 160 may map the signal image (e.g., the signal image 201 of FIG. 2) and the extracted metadata to each other. While storing the metadata in the metadata DB 122, the processor 160 may also store information on the signal image mapped to the metadata. For example, the processor 160 may extract, as the metadata associated with the signal image, the number of occurrences of a pm signal, an occurrence time of the pm signal, time interval information, and chamber information, which are to be represented in the signal image. However, a type of metadata to be extracted by the processor 160 is not limited to the foregoing example.

In an example, the electronic device 101 may further include a class label DB 123. The class label DB 123 may refer to a DB that stores label information on labels into which a plurality of signal images generated by the processor 160 is respectively classified. The label information may also include information on a point in time at which a label is assigned to each signal image, in addition to the information on a label into which each signal image is classified.

In an example, before inputting each of the plurality of signal images to a neural network 130, the processor 160 may perform labeling on each of the plurality of signal images and classify them into temporary labels. In the class label DB 123, information on the temporary labels into which the plurality of signal images is classified may be stored until the plurality of signal images are input to the neural network 130.

Hereinafter, a method in which the processor 160 performs labeling on each of a plurality of signal images before inputting them to the neural network 130 and classifies them into temporary labels will be described. Among the plurality of signal images stored in the image DB 121, the processor 160 may determine, as a normal label, a temporary label of a signal image that explicitly has a feature or pattern corresponding to the normal label. The processor 160 may also determine, as an abnormal label, a temporary label of a signal image that explicitly has a feature or pattern corresponding to the abnormal label among the plurality of signal images. The processor 160 may train a sub-neural network using signal images for which temporary labels have been determined. For example, the memory 170 may be representative of storing the trained sub-neural network. The sub-neural network may refer to a model having a machine learning structure designed to determine a label into which a signal image is to be classified in response to an input of a signal image. The sub-neural network may be trained based on training data including a pair of training input data (e.g., a signal image for which a temporary label is determined) and training output data (e.g., the temporary label of the signal image). The sub-neural network may be trained to output a training output from a training input. The processor 160 may input, to the trained sub-neural network, each of remaining signal images, excluding the signal images for which the temporary labels are determined among the plurality of signal images stored in the image DB 121, and determine a temporary label of each of the remaining signal images. The processor 160 may set the temporary label determined for each of the remaining signal images as a pseudo label. However, the method of determining temporary labels of a plurality of signal images is not necessarily limited thereto, and a user may perform labeling on each signal image to determine a temporary label of a signal image.

In an example, the electronic device 101 may include the neural network 130 configured to perform representation learning. The neural network 130 may be representative of various combinations of plural neural networks, where each of the plural neural networks may include one or more layers. The processor 160 may train the neural network 130 (e.g., train a single neural network with all of the plural neural networks or one or more neural networks respectively having any combination of the respective plural neural networks, including neural network examples where some of the neural networks of the single neural network are previously trained or not trained in different training stages of the single neural network) through representation learning using, as training data, a plurality of signal images, metadata mapped to the plurality of signal images, and label information on temporary labels into which the plurality of signal images are classified.

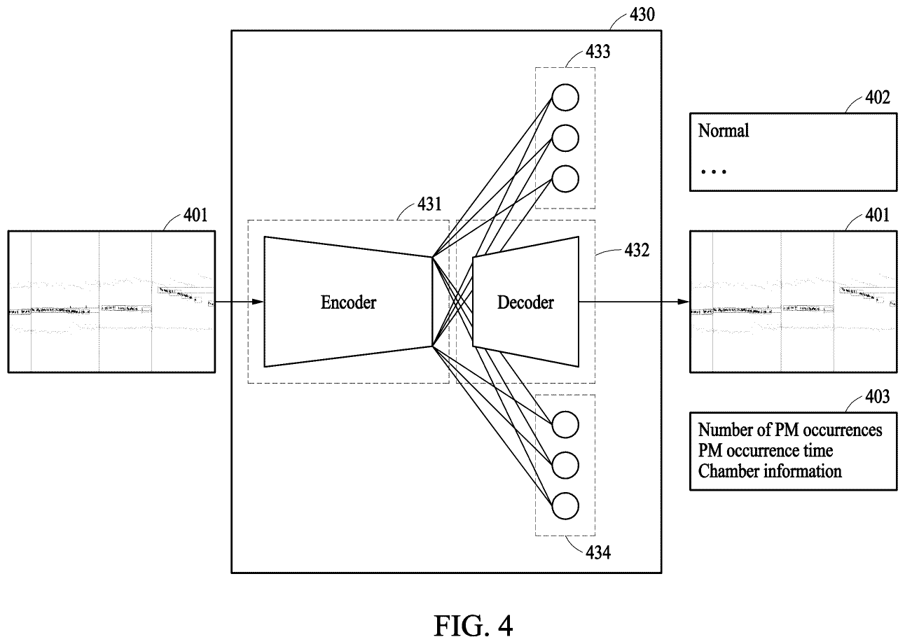

That is, the processor 160 may use, as one training data, one signal image, metadata mapped to the signal image, and information on a temporary label into which the signal image is classified (e.g., when the neural network 130 includes respective neural networks for an encoder-decoder, a corresponding label extractor/classifier, and a corresponding metadata extractor/classifier). For example, when the neural network 130 includes respective neural networks for the trained/or untrained encoder-decoder or merely the trained/untrained encoder, the currently being trained corresponding label extractor/classifier, and the currently trained corresponding metadata extractor/classifier, the processor 160 may extract a signal image from the image DB 121, extract metadata mapped to the extracted signal image from the metadata DB 122, and extract information on a temporary label into which the extracted signal image is classified from the class label DB 123. In an example, the processor 160 may respectively train separate neural networks represented by the neural network 130 (e.g., train one neural network to extract features from a signal image, train another neural network to extract information on the temporary label, and/or train still another neural network to extract metadata). As another non-limiting example, the training of the neural network 130 may include: training the neural network 130 to extract features from the signal image when the neural network includes the feature extractor; training the neural network 130 to extract features from the signal image and to reconstruct the signal image from the extracted features when the neural network 130 includes the feature extractor and a decoder, for example; training the neural network 130 to reconstruct the signal image from extracted features when the neural network 130 includes the trained feature extractor and the example decoder; training the neural network 130 to extract features from the signal image, and extract the information on the temporary label and/or extract the metadata when the neural network 130 respectively includes the feature extractor, and a corresponding label extractor/classifier and/or a corresponding metadata extractor/classifier; training the neural network 130 to extract features from the signal image, reconstruct the signal image from extracted features, and extract the information on the temporary label and/or extract the metadata when the neural network 130 respectively includes the feature extractor, the decoder, and the corresponding label extractor/classifier and/or the corresponding metadata extractor/classifier; training the neural network 130 to extract the information on the temporary label and/or extract the metadata when the neural network 130 respectively includes the trained feature extractor, and the corresponding label extractor/classifier and/or the corresponding metadata extractor/classifier; and training the neural network 130 to extract the information on the temporary label and/or extract the metadata when the neural network 130 respectively includes the trained feature extractor, the trained decoder, and the corresponding label extractor/classifier and/or the corresponding metadata extractor/classifier. Additionally, while examples are provided with the neural network may include various combinations of the trained/currently trained encoder, the trained/currently trained decoder, the trained/currently trained label extractor/classifier, and/or the trained/currently metadata extractor/classifier, examples are not limited thereto and additional neural networks may be included in, or represented by, the neural network 130. The above description regarding the various examples of the neural network 130 are also applicable to all below discussions of example neural networks (e.g., including neural network 430 discussed with respect to FIGS. 4-6).

In an example, after training the neural network 130 using the plurality of signal images, the processor 160 may generate a feature map of the plurality of signal images from the trained neural network 130. For example, the processor 160 may extract latent features (e.g., also referred to as latent vectors) of each of the plurality of signal images using the trained neural network 130. In an example, the respective extracted latent features may be generated by a feature extractor (e.g., the encoder) of the neural network 130. For example, such a feature extractor may be provided a signal image and extract latent features from that signal image, or multiple signal images may be provided to the feature extractor and respective latent features may be extracted. The processor 160 may generate the feature map in which each signal image is represented as one point, based on a distance between the extracted latent features. For example, each of the respectively extracted latent features may be collected and collectively arranged in one feature map, or the trained neural network 130 may generate the one feature map (e.g., as an output of the feature extractor). The processor 160 may select a mislabeled signal image from the generated feature map and correct labeling of the selected signal image in operation 140. That is, the processor 160 may correct a label into which the selected signal image is classified.

In an example, after correcting a label into which some signal image selected from a feature map is classified, the processor 160 may store a result of the correcting in the class label DB 123. The processor 160 may update the label information based on the correcting of the label into which the selected signal image is classified. The processor 160 may re-train the neural network 130 by using, as training data, a plurality of signal images, metadata corresponding to the plurality of signal images, and the updated label information. For example, when the processor 160 changes the label into which the signal image selected from the feature map is classified from a normal label, which is a temporary label, to an abnormal label, the processor 160 may update the label into which the selected signal image is classified to the abnormal label and store the updated label in the class label DB 123. When training the neural network 130 by using the plurality of signal images once, the processor 160 may update, as one epoch, a point in time at which the label is classified for the selected signal image to a point in time at which the neural network 130 is trained.

In an example, the processor 160 may train the neural network 130 a plurality of epochs (e.g., 50 epochs), and each time of training, the processor 160 may select a mislabeled signal image and correct labeling of the selected signal image. For example, the processor 160 may train the neural network 130 using the same plurality of signal images 50 times. In this example, the processor 160 may update label information on the plurality of signal images through operation 140 each time of training the neural network 130 once and may then perform subsequent training on the neural network 130 using the updated label information. In this way, the processor 160 may perform active learning on the neural network 130.

In an example, when the training of the neural network 130 ends, the processor 160 may obtain, as classification data 150, the label information on a label to which each of the plurality of signal images is classified. Accordingly, the processor 160 may obtain a final label into which each of the plurality of signal images is classified by repeating operations of selecting a mislabeled signal image from among the plurality of signal images using the neural network 130 and correcting the labeling.

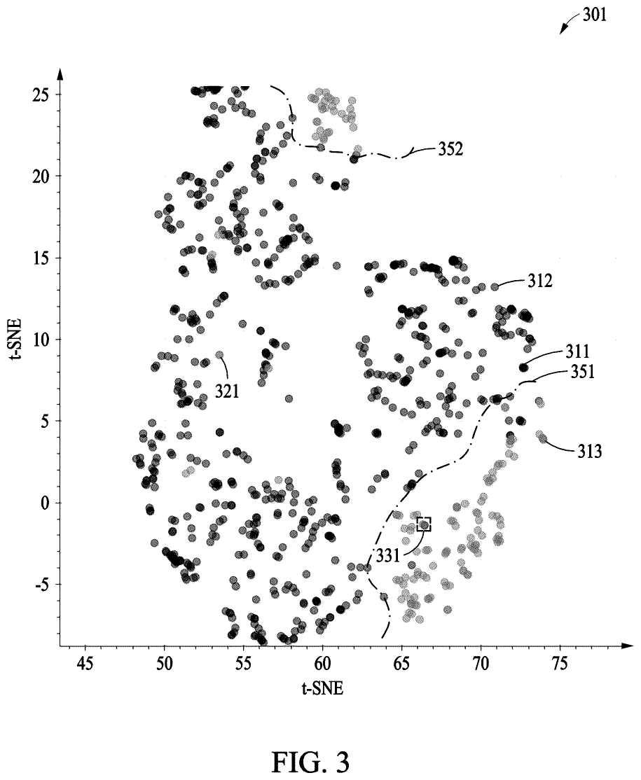

FIG. 3 illustrates an example of identifying, by an electronic device, a mislabeled signal image from a feature map, in accordance with one or more embodiments.

In an example, an electronic device (e.g., the electronic device 101 of FIG. 1, as a non-limiting example) may generate a feature map 301 in which each of a plurality of signal images is indicated as a point from a trained neural network (e.g., the neural network 130 of FIG. 1, as a non-limiting example). For example, the feature map 301 may be an image that is generated as a processor of the electronic device (e.g., the processor 160 of FIG. 1, as a non-limiting example) extracts latent features for each of the plurality of signal images from the trained neural network 130, calculates distance information indicating a distance (e.g., Euclidean distance) between the extracted latent features, and reduces data corresponding to the extracted latent features to two dimensions based on the calculated distance information. The processor may use a t-distributed stochastic neighbor embedding (t-SNE) technique to reduce the dimensionality of the data to two dimensions and visualize them.

In the feature map 301, each of the plurality of signal images may correspond to one point (e.g., a point 311, a point 312, a point 313, etc.), and at each point, a pre-classified label may be represented for a signal image corresponding to a corresponding point. For example, when a first signal image is classified as a normal label before being input to the neural network 130, the point 311 indicating the first signal image may be marked in a first color (e.g., blue) corresponding to the normal label in the feature map 301. For another example, when a second signal image is classified as an abnormal label before being input to the neural network 130, the point 312 indicating the second signal image may be marked in a second color (e.g., red) corresponding to the abnormal label in the feature map 301.

In an example, the processor may select a mislabeled signal image among the plurality of signal images from the generated feature map 301. Hereinafter, a method in which the processor selects a mislabeled signal image among a plurality of signal images from the feature map 301 will be described in detail.

In an example, when, in the generated feature map 301, signal images corresponding to a first number of different points that is preset in order of proximity to a target point (e.g., a point 321) corresponding to a target signal image classified as a first label (e.g., an abnormal image) are all classified as a second label (e.g., a normal label), the processor may select the target signal image corresponding to the target point (e.g., the point 321) as a mislabeled signal image. The processor may correct labeling of the selected signal image by classifying the selected signal image as the second label (e.g., the abnormal label). For example, the preset first number may be ten but is not limited thereto.

In an example, when two points corresponding to two signal images classified as different labels while being indicated at the same position (e.g., a position 331) in the generated feature map 301 are identified, the processor may select, as a mislabeled signal image, a signal image corresponding to one of the identified two points that is not classified as a third label (e.g., the abnormal label). The processor may correct labeling of the selected signal image by classifying the selected signal image as the third label (e.g., the abnormal label). The third label may be a label corresponding to a direction (e.g., a right direction) toward a position (e.g., the position 331) of the two points with respect to a boundary line (e.g., a boundary line 351) disposed around the position (e.g., the position 331) of the identified two points.

For example, the processor may mark a plurality of points respectively corresponding to a plurality of signal images on the generated feature map 301, and each of the plurality of points may represent a label into which a signal image corresponding to a corresponding point is classified. For example, a point may represent, in color, a label into which a signal image corresponding to the point is classified. In this example, the processor may generate a boundary line (e.g., boundary lines 351 and 352) for classifying a cluster of each label in the feature map 301. For example, the processor may generate a plurality of boundary lines within the feature map 301. Referring to the example of FIG. 3, points (e.g., the point 313) corresponding to signal images classified as the abnormal label may be represented mainly in the right direction from the boundary line 351, and points (e.g., the point 311) corresponding to signal images classified as the normal label may be represented mainly in the left direction from the boundary line 351. In this case, the processor may determine a label corresponding to the right direction with respect to the boundary line 351 as the abnormal label and may determine a label corresponding to the left direction with respect to the boundary line 351 as the normal label.

In an example, when half of signal images corresponding to a second number of different points that is preset in order of proximity to one point is classified as the normal label and the other half of the signal images is classified as the abnormal label, the processor may determine that the one point constitutes a portion of a boundary line. The processor may generate a boundary line in the feature map 301 by identifying points constituting the boundary line as described above.

However, the method of selecting a mislabeled signal image among a plurality of signal images from the feature map 301 is not limited to the foregoing examples, and other methods may also be used to select a mislabeled signal image.

FIG. 4 illustrates an example neural network configured to perform representation learning, in accordance with one or more embodiments.

In an example, a neural network 430 (e.g., the neural network 130 of FIG. 1, as a non-limiting example) included in an electronic device (e.g., the electronic device 101 of FIG. 1, as a non-limiting example) may further include two headers in addition to a decoder header, based on an encoder-decoder structure. The neural network 430 may include an encoder 431 configured to receive a signal image, a decoder 432 configured to restore a signal image input to the encoder 431, and two headers 433 and 434. The two headers 433 and 434 may include a classification header 433 configured to output a label into which the signal image is classified, and a metadata header 434 configured to output metadata mapped to the signal image.

A processor of the electronic device (e.g., the processor 160 of FIG. 1, as a non-limiting example) may input a signal image 401 to the neural network 430 as training input data. The encoder 431 of the neural network 430 may receive the signal image 401 as an input. The encoder 431 may output an intermediate representation in response to the signal image 401 being input as an input image. The intermediate representation output from the encoder 431 may be input to the decoder 432. The decoder 432 may serve to restore the signal image 401 input to the neural network 430 to an output image. That is, in response to the intermediate representation being input to the decoder 432, the processor may train the neural network 430 such that the signal image 401 is output as the output image through the decoder header of the decoder 432.

The neural network 430 may include the classification header 433. The processor may train the neural network 430 such that it outputs a label classified for the signal image 401 through the classification header 433 of the neural network 430. For example, when training the neural network 430 for one epoch, the processor may train the neural network 430 such that it outputs a temporary label for the signal image 401 through the classification header 433 of the neural network 430.

The neural network 430 may include the metadata header 434. The processor may extract and obtain metadata mapped to the signal image 401 from a metadata DB (e.g., the metadata DB 122 of FIG. 1). The processor may train the neural network 430 such that it outputs the metadata mapped to the signal image 401 through the metadata header 434 of the neural network 430.

As described above, the processor may train the neural network 430 such that, in response to the signal image 401 being input, the signal image 401 input to the neural network 430 is output through the decoder header of the decoder 432, the label classified for the signal image 401 is output through the classification header 433, and the metadata mapped to the signal image 401 is output through the metadata header 434.

In an example, the processor may train the neural network 430 based on a total loss Lₜₒₜₐₗ including a plurality of losses. The total loss Lₜₒₜₐₗ for training the neural network 430 may be expressed as Equation 1 below, for example.

$${ℒ}_{total} = {λ}_{clf} * {ℒ}_{clf} + {λ}_{meta} * {ℒ}_{meta} + ( 1 - {λ}_{meta} - {λ}_{clf} ) {ℒ}_{rep} \qquad Equation 1$$

In Equation 1 above, L_{clf} denotes a classification loss calculated from the classification header 433, Lₘₑₜₐ denotes a metadata loss calculated from the metadata header 434, and Lᵣₑₚ denotes a representation loss calculated from the decoder header. λ_{ctf} denotes a first weight applied to the classification loss, and λₘₑₜₐ denotes a second weight applied to the metadata loss.

For example, when a user determines a temporary label of a plurality of signal images, the classification loss L_{off} may be expressed as Equation 2 below.

$${ℒ}_{clf} = α * ( 1 - H ( {y}_{i}^{′} ) ) * CE ( {y}_{i} ) \qquad Equation 2$$

In Equation 2, H(.) denotes a normalized entropy function, and CE(.) denotes a cross-entropy loss.

The processor may calculate a normalized entropy value H(yᵢ′) of recent n label history vectors yᵢ′ of the user that determine a temporary label of a plurality of signal images. For example, when the user consistently performs labeling on the signal images, a normalized entropy value H(yᵢ′) of label history vectors may decrease. The processor may add the normalized entropy value as a weight of the cross-entropy loss such that signal images present at a boundary between different labels are not selected as a mislabeled signal image and may therefore allow the corresponding signal images to move to a center of a label group.

In an example, the processor may calculate first temporary output data from the decoder header of the decoder 432, based on inputting a signal image (e.g., the signal image 401) to the encoder 431 as training input data. The processor may calculate a representation loss Lᵣₑₚ based on the calculated first temporary output data and the signal image input to the encoder 431. That is, the processor may calculate the representation loss Lᵣₑₚ that indicates an error between the first temporary output data generated by inputting the signal image to the encoder 431 and the signal image input to the encoder 431.

In addition, the processor may calculate second temporary output data 402 that is output from the classification header 433, based on inputting the signal image (e.g., the signal image 401) to the encoder 431 as the training input data. The processor may calculate a classification loss L_{clf} based on the calculated second temporary output data 402 and a label into which the signal image input to the encoder 431 is classified. That is, the processor may calculate the classification loss L_{clf} that indicates an error between the second temporary output data 402 generated by inputting the signal image to the encoder 431 and the label classified for the signal image input to the encoder 431.

The processor may calculate third temporary output data 403 that is output from the metadata header 434, based on inputting the signal image (e.g., the signal image 401) to the encoder 431 as the training input data. The processor may calculate a metadata loss Lₘₑₜₐ based on the calculated third temporary output data 403 and metadata mapped to the signal image input to the encoder 431. That is, the processor may calculate the metadata loss Lₘₑₜₐ that indicates an error between the third temporary output data 403 generated by inputting the signal image to the encoder 431 and the metadata mapped to the signal image input to the encoder 431.

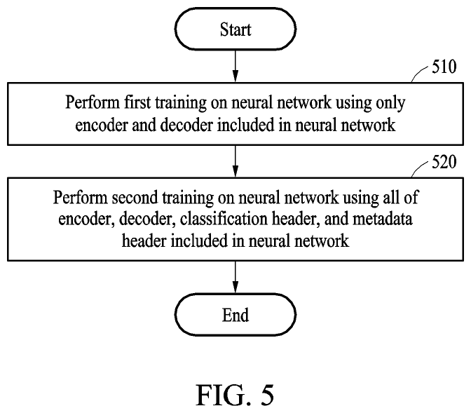

FIG. 5 illustrates an example method of training a neural network by an electronic device, in accordance with one or more embodiments.

In an example, a processor of an electronic device (e.g., the processor 160 of the electronic device 101 of FIG. 1, as a non-limiting example) may train a neural network (e.g., the neural network 430 of FIG. 4, as a non-limiting example) in two stages.

In operation 510, the processor may perform first training on a neural network that may include or only uses an encoder and a decoder (e.g., the encoder 431 and the decoder 432 of the neural network 430 of FIG. 4, as non-limiting examples). In an example, where the network also includes a classification header and a metadata header (e.g., the classification header 433 and the metaheader 434, as non-limiting examples), only the encoder 431 and decode 432 may be trained, and only the encoder 431 and decoder 432 may be implemented. For explanatory purposes, the below description with respect to FIG. 5 will be made with reference to the neural network 430 of FIG. 4. The processor may perform the first training on the neural network 430 based on a representation loss Lᵣₑₚ.

While performing the first training, the processor may not consider a classification loss L_{clf} calculated from the classification header 433 and a metadata loss Lₘₑₜₐ calculated from the metadata header 434. That is, the processor may perform the first training on the neural network 430 by setting, as zero (0), a first weight λ_{clf} applied to the classification loss L_{clf} in a total loss Lₜₒₐₗ and a second weight λₘₑₜₐ applied to the metadata loss Lₘₑₜₐ in the total loss Lₜₒₜₐₗ. In an example, the loss Lₜₒₜₐₗ for the first training may be the representation loss Lᵣₑₚ, i.e., Lₜₒₜₐₗ=Lᵣₑₚ, without consideration of the first weight λ_{clf}, the classification loss L_{clf}, the second weight λₘₑₜₐ, and the metadata loss Lₘₑₜₐ. Similarly, in an example, the first training may include training a neural network that only includes the encoder 431 and the decoder 432, and the classification header 433 and the metaheader 434 could be added to the trained neural network result of the first training, thereby generating the neural network 430 for the subsequent performing the second training that includes the trained encoder 431, the trained decoder 432, the classification header 433, and the metaheader 434. As an alternative, the trained encoder 431 may be added to another neural network that includes the classification header 433 and the metaheader 434, and the second training of the neural network 430 may be considered the training of the classification header 433 and the metaheader 434 using the trained encoder. As noted above with respect to neural network 130, these are non-limiting examples and alternate orderings of neural networks represented by the neural network 430 and the respective training of these neural networks in various combinations are available.

Thus, in an example, when the calculated representation loss Lᵣₑₚ is determined to decrease to be less than a threshold loss during the first training using a plurality of signal images stored in an image DB (e.g., the image DB 121), the processor may end the first training and consider this calculated representation loss Lᵣₑₚ that is determined to be less than the threshold loss to be a final representation loss Lᵣₑₚ). After ending the first training, the processor may perform second training on the neural network 430, i.e., the processor performs the second training of a result of the first training. For example, the second training may be performed on a first neural network that includes the trained encoder 431 (or the trained encoder and decoder 431, 432) and the classification header and metaheader 433, 434 that were not trained in the first training, or the second training may be performed on a first neural network generated by adding the classification header and metaheader 433, 434 to the trained neural network (including the trained encoder 431 (or trained encoder and decoder 431, 432) result of the first training. Additionally, as noted above, during the first training the neural network 430 may include each of the encoder and decoder 431, 432 and the classification header and metaheader 433, 434, but may only use/train the encoder and decoder 431, 432 in the first training, and train at least the classification header and metaheader 433, 434 in the second training.

Thus, in operation 520, the processor of the electronic device may perform the second training on the neural network 430 using the trained encoder 431, the classification header 433, and the metadata header 434 included in the neural network 430. In another example, the second training of the neural network 430 may further include use of the trained decoder 432. In still another example, each of the trained encoder and decoder 431, 432 and the classification header and metaheader 433, 434 may be trained in the second training.

The processor of the electronic device may perform the second training on the neural network 430 based on the total loss Lₜₒₜₐₗ including the representation loss Lᵣₑₚ, the classification loss L_{clf}, and the metadata loss Lₘₑₜₐ. In an example, the trained parameters (e.g., respective connection weights) of the trained encoder included in the neural network 430 (or the trained encoder and decoder 431, 432 when both are included in the neural network 430) may be fixed during the second training. The processor may perform the second training on the neural network 430 by setting, to be greater than 0 and less than 1, both a first weight Act to be applied to the classification loss L_{clf} in the total loss Lₜₒₜₐₗ and a second weight λₘₑₜₐ to be applied to the metadata loss Lₘₑₜₐ in the total loss Lₜₒₜₐₗ, and setting the second weight λₘₑₜₐ to be greater than the first weight λ_{clf}, for example. In an example, while the processor is performing the second training on the neural network 430, the condition of Equation 3 below may be satisfied.

$$1 > {λ}_{meta} > {λ}_{clf} > 0 \qquad Equation 3$$

While performing the second training on the neural network 430, the processor may adjust a hierarchy of clusters using the first weight λ_{clf} and the second weight λₘₑₜₐ.

For example, the processor may generate a final group for each label in a feature map generated from the neural network 430 to determine whether a label is normal by clustering similar images among a plurality of signal images in which metadata is reflected. In this case, the processor may cluster similar images among the plurality of signal images by setting the hierarchy of clusters. For example, the processor may cluster images with similar metadata and labels among the plurality of signal images. For another example, the processor may further subdivide the hierarchy of the clusters, and cluster images that are similar to each other in terms of the number of occurrences of a pm signal, an occurrence time of the pm signal, chamber information, and labels among the plurality of signal images. Hereinafter, for the convenience of description, the following description will focus on an example of clustering, by the processor, signal images with similar metadata and labels among a plurality of signal images.

In an example, the processor of the electronic device may calculate a first clustering score for metadata and a second clustering score for a label from a feature map generated from or using the encoder 431 of the neural network 430, as a non-limiting example, while performing the second training on the neural network 430 using a plurality of signal images. The processor may set a first threshold score for metadata and a second threshold score for a label. For example, when the first clustering score exceeds the first threshold score and the second clustering score exceeds the second threshold score during the second training performed on the neural network 430, the processor may end the second training on the neural network 430. As the first clustering score exceeds the first threshold score and the second clustering score exceeds the second threshold score, the processor may cluster signal images with similar metadata and similar labels into which the signal images are to be classified. For example, the first threshold score may be a value within a range of 0.5 to 0.7, and the second threshold score may also be a value within a range of 0.5 to 0.7.

In an example, for each of a plurality of points corresponding to a plurality of signal images in a feature map generated from the neural network 430, the processor of the electronic device may assign a first score to a point by determining whether signal images corresponding to a second number of different points that are preset in order of proximity to the point are all classified as the same label as one into which a signal image corresponding to the point is classified. For example, the second number may be five but is not limited thereto. In this example, when the signal images corresponding to the second number of different points that are preset in order of proximity to the point are all classified as the same label as the label into which the signal image corresponding to the point is classified, the processor may assign the first score of 1 to the corresponding point. In this example, when at least one of the signal images corresponding to the second number of different points that are preset in order of proximity to the point is not classified as the same label as the label into which the signal image corresponding to the point is classified, the processor may assign the first score of 0 to the corresponding point. The processor may calculate, as the first clustering score, an average of first scores respectively assigned to the plurality of points corresponding to the plurality of signal images in the feature map. That the first clustering score is 0 may indicate that, for a point corresponding to a signal image classified as a target label (e.g., an abnormal label or a normal label) in the feature map, not all of the second number of different points preset in order of proximity to the point are classified as the target label. That is, that the first clustering score is 0 may indicate that a cluster of points corresponding to signal images classified as the same label in the feature map is not generated. Conversely, that the first clustering score is 1 may indicate that, for the point corresponding to the signal image classified as the target label in the feature map, the second number of different points preset in order of proximity to the point are all classified as the target label. That is, that the first clustering score is 1 may indicate that the points corresponding to the signal images classified as the same label in the feature map form a cluster. As the first clustering score is closer to 1, the points corresponding to the signal images classified as the same label may be shown in a clustered form in the feature map.

In an example, for each of a plurality of points corresponding to a plurality of signal images in a feature map generated from the neural network 430, the processor of the electronic device may assign a second score to a point by determining whether signal images corresponding to a third number of different points that are preset in order of proximity to the point have all similar metadata to that of a signal image corresponding to the point. For example, the third number may be three but is not limited thereto. For example, the processor may calculate a similarity between the metadata using pieces of information included in the metadata (e.g., the number of occurrences/occurrence time of a pm signal, time interval information, and chamber information), and may determine whether the metadata is similar to each other. For example, the processor may calculate a similarity score between the metadata using the pieces of information included in each of the metadata, and may determine that the metadata are similar to each other when the calculated similarity score is greater than or equal to a threshold score. In this example, when the signal images corresponding to the third number of different points preset in order of proximity to the point all have the similar metadata to the metadata corresponding to the point, the processor may assign the second score of 1 to the corresponding point. In this example, when at least one of the signal images corresponding to the third number of different points preset in order of proximity to the corresponding point does not have the similar metadata to the metadata corresponding to the point, the processor may assign the second score of 0 to the corresponding point. The processor may calculate, as the second clustering score, an average of second scores respectively assigned to the plurality of points corresponding to the plurality of signal images in the feature map. That the second clustering score is 0 may indicate that a cluster of points corresponding to signal images having similar metadata is not generated in the feature map. That the second clustering score is 1 may indicate that points corresponding to signal images having similar metadata form a cluster with each other in the feature map.

In an example, the processor of the electronic device may perform the second training on the neural network 430 while changing the first weight λ_{clf} and the second weight λₘₑₜₐ. For each epoch, the processor may generate a feature map by extracting latent features for each of a plurality of signal images, and calculate the first clustering score and the second clustering score from the generated feature map. As described above, when the first clustering score exceeds the first threshold score and the second clustering score exceeds the second threshold score, the processor may end the second training on the neural network 430. In this case, as one of the first clustering score and the second clustering score is closer to a corresponding threshold score (e.g., the respective first and second threshold scores), the processor may change the first weight λ_{clf} and the second weight λₘₑₜₐ to be close to 0.

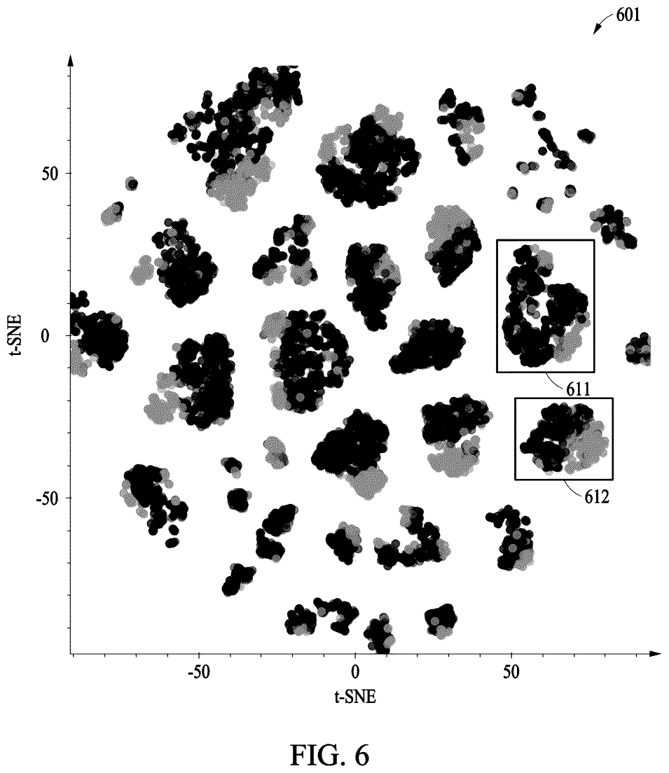

FIG. 6 illustrates an example feature map generated by an electronic device using a trained neural network, in accordance with one or more embodiments.

In an example, a processor of an electronic device (e.g., the electronic device 101 of FIG. 1) may perform both first training and second training each time it trains a neural network (e.g., the neural network 130 of FIG. 1 or the neural network 430 of FIG. 4) once. For example, a first training and a plurality of epochs of second training may be performed at a first time based on a first plurality of signal images extracted from raw data of a corresponding first time, and the first training and a corresponding plurality of epochs of second training may be performed at second first time based on second plurality of signal images extracted from raw data of a corresponding second time. The processor may generate a feature map 601 of a plurality of signal images from the neural network for which the first training and the second training are completed. Referring to FIG. 6, the processor may cluster points corresponding to signal images having similar metadata and labels among the plurality of signal images in the feature map 601. In the feature map 601, points corresponding to signal images having similar metadata may be grouped into a plurality of groups (e.g., groups 611 and 612). In addition, in each of the plurality of groups (e.g., groups 611 and 612), points corresponding to signal images classified as a normal label and points corresponding to signal images classified as an abnormal label may be separated from each other to be clustered.

Accordingly, in a group (e.g., the group 611 or the group 612) formed by points corresponding to signal images having similar metadata in the feature map 601, points corresponding to signal images classified as the normal label and points corresponding to signal images classified as the abnormal label are respectively clustered by being separated from each other, and thus a similarity analysis for classifying the signal images into the normal label and the abnormal label may be readily performed.

In an example, the processor of the electronic device may repeatedly train the neural network over a plurality of epochs. Each time the processor trains the neural network in a corresponding epoch, the processor may update label information by correcting a label of a mislabeled signal image (e.g., operation 140 of FIG. 1). Therefore, while repeatedly training the neural network, the processor may group points corresponding to signal images having similar metadata by separating points corresponding to signal images classified as the normal label from points corresponding to signal images classified as the abnormal label, for each group. In an example, when a ratio of a total number of signal images selected as being mislabeled from a feature map generated based on an operation of the neural network (e.g., as or from the data extracted by the encoder) to a total number of a plurality of signal images in the feature map decreases to be less than a threshold ratio, the processor may end training the neural network.

Each time this training is completed, the resulting signal images that have been labeled as being abnormal may accurately reflect respective abnormal signal images, which can thereby indicate sensor(s′) readings in a wafer fabrication system (e.g., the fabrication system 100 of FIG. 1). For example, the resultant abnormal signal images may respectively reflect abnormal characteristics of a wafer at each of multiple fabrication stage/stations (e.g., before, during, or after fabrication of any respective stage/station, the operation of the respective stage/station, and/or the state of the fabrication equipment at that respective stage/station).

The processors, memories, sensors, fabrication equipment, electronic devices and system described herein, including descriptions with respect to respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-6 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, comprising:
training a neural network through representation learning using, as training data, a plurality of signal images, a respective metadata mapped to each of the plurality of signal images, and a respective temporary classified label of each of the plurality of signal images;
extracting latent features for each of the plurality of signal images using the trained neural network, and generating a feature map representing the plurality of signal images based on respective differences between the extracted latent features; and
correcting label information, for a signal image and for a corresponding temporary classification label in the respective temporary classified labels, to have corrected classification information, including determining that the corresponding temporary classification label of the signal image is mislabeled using the generated feature map.

2. The method of claim 1, wherein the correcting of the label information comprises updating the corresponding temporary classification label, in the respective temporary classified labels, to be the corrected classification information, and
wherein the training of the neural network comprises training the neural network using, as corresponding training data, the plurality of signal images, the respective metadata corresponding to the plurality of signal images, and updated label information that correspond to the respective temporary classification labels with the updated corresponding temporary classification label.

3. The method of claim 1, wherein the determining that the corresponding temporary classification label of the signal image is mislabeled comprises:
with the feature map including a target point corresponding to a target signal image which has been classified as a first label, selecting the target signal image corresponding to the signal image to determine the mislabeled corresponding temporary classification label based on multiple signal images, corresponding to a respective first number of different points in the generated feature map within a first proximity to the target point, all having been classified as a second label different from the first label.

4. The method of claim 1, wherein the determining that the corresponding temporary classification label of the signal image is mislabeled comprises determining the mislabeled corresponding temporary classification label by selecting the signal image from among two signal images, of the plurality of signal images, that have been respectively classified as different labels and that are represented as respective points in the feature map having a same position, including selecting the signal image that is not classified as a third label, and
wherein the third label is a label corresponding to a direction toward the respective points with respect to a boundary line disposed around the same position.

5. The method of claim 1, wherein the neural network comprises:
an encoder configured to generate extracted data in response to a corresponding signal image of the plurality of signal images being input to the encoder, a classification header configured to output a classified label of the corresponding signal image, and a metadata header configured to output metadata mapped to the corresponding signal image.

6. The method of claim 5, wherein the neural network further comprises a decoder configured to restore the corresponding signal image using extracted data, and
wherein the training of the neural network comprises, for each of the plurality of signal images, training the encoder, the decoder, the classification header, and the metadata header based on a representation loss with respect to the corresponding signal image and the restored corresponding signal image, a classification loss with respect to a training classification label and an output label of the classification header that is dependent on an operation of the encoder with respect to the corresponding signal image, and a metadata loss with respect to a training metadata and an output of the metadata header that is dependent on the operation of the encoder.

7. The method of claim 5, wherein the neural network further comprises a decoder configured to restore the corresponding signal image using the extracted data, and
wherein the training of the neural network comprises:
performing a first training of the encoder and the decoder; and
performing a second training using the first trained encoder, the classification header, and the metadata header.

8. The method of claim 7, wherein the performing of the first training comprises:
generating first temporary output data by a decoder header of the decoder based on the extracted data, calculating a representation loss based on the calculated first temporary output data and the corresponding signal image, and performing the first training of only the encoder and the decoder based on the calculated representation loss.

9. The method of claim 8,
wherein the performing of the first training comprises performing the first training until a corresponding calculated representation loss decreases to be less than a threshold loss, with the plurality of signal images being used as training data for the corresponding signal image.

10. The method of claim 8, wherein the performing of the second training comprises:
generating, dependent on another corresponding signal image being provided to the first trained encoder, second temporary output data by the classification header and third temporary output data by the metadata header, respectively;
generating a classification loss based on the second temporary output data and a previously classified label of the other corresponding signal image, and a metadata loss based on the third temporary output data and previously mapped metadata of the other corresponding signal image; and
performing the second training based on a total loss comprising the calculated representation loss, the calculated classification loss, and the calculated metadata loss.

11. The method of claim 10, wherein the performing of the second training comprises:
ending the second training upon a first clustering score for first metadata calculated from the generated feature map exceeding a first threshold score and a second clustering score for a label calculated from the generated feature map exceeding a second threshold score, while the second training is being performed using the plurality of signal images as training data for the other corresponding signal image.

12. The method of claim 11, wherein the performing of the second training comprises:
for each corresponding point of a plurality of points corresponding to the plurality of signal images in the generated feature map, assigning a respective first score to the corresponding point that corresponds to a corresponding first signal image based on whether multiple signal images corresponding to a second number of different points, within a preset proximity to the corresponding point, have each been classified as having a same label as the corresponding first signal image; and
calculating, as the first clustering score, an average of the respective first scores.

13. The method of claim 11, wherein the performing of the second training comprises:
for each corresponding point of a plurality of points in the generated feature map corresponding to the plurality of signal images, assigning a respective second score to the corresponding point, which corresponds to a corresponding second signal image, that has a third number of different points within a preset proximity to the corresponding point that all have a determined similar metadata to metadata of the corresponding second signal image; and
calculating, as the second clustering score, an average of the respective second scores.

14. The method of claim 1, further comprising:
labeling classifications of each of a plurality of signal images to generate the respective temporary classified labels; and
training an encoder to perform the extraction of the latent features,
wherein the training of the neural network includes training a classification header and a metadata header of the neural network based on results on the trained encoder, a classification loss, and a metadata loss, with each epoch of the training of the neural network including a corresponding performance of the correcting of the label information, and
wherein, when a final epoch of the plurality of epochs is determined to be the final epoch that completes the training of the classification header and the metadata header, one or more final classified abnormal signal images are identified by corresponding final outputs of the classification header in the final epoch and by a corresponding final performance of the correcting of the label information.

15. An electronic device, comprising:
a processor configured to:
perform labeling on each of a plurality of signal images and classify each of the plurality of signal images into respective temporary classified labels;
train a neural network through representation learning using, as training data, a plurality of signal images, a respective metadata mapped to each of the plurality of signal images, and the respective temporary classified label of each of the plurality of signal images;
extract latent features for each of the plurality of signal images using the trained neural network, and generate a feature map representing the plurality of signal images based on respective differences between the extracted latent features; and
correct label information, for a signal image and for a corresponding temporary classification label in the respective temporary classified labels, to have corrected classification information, including determining that the corresponding temporary classification label of the signal image is mislabeled using the generated feature map.

16. The electronic device of claim 15,
wherein, for the correcting of the label information, the processor is configured to update the corresponding temporary classification label, in the respective temporary classified labels, to be the corrected classification information, and
wherein, for the training of the neural network, the processor is configured to train the neural network using, as corresponding training data, the plurality of signal images, the respective metadata corresponding to the plurality of signal images, and updated label information that correspond to the respective temporary classification labels with the updated corresponding temporary classification label.

17. The electronic device of claim 15, wherein, for the determining that the corresponding temporary classification label of the signal image is mislabeled, the processor is configured to:
with the feature map including a target point corresponding to a target signal image which has been classified as a first label, select the target signal image corresponding to the signal image to determine the mislabeled corresponding temporary classification label based on multiple signal images, corresponding to a respective first number of different points in the generated feature map within a first proximity to the target point, all having been classified as a second label different from the first label.

18. The electronic device of claim 15, wherein the neural network comprises:
an encoder configured to generate extracted data in response to a corresponding signal image of the plurality of signal images being input to the encoder, a classification header configured to output a classified label of the corresponding signal image, and a metadata header configured to output metadata mapped to the corresponding signal image.

19. The electronic device of claim 18, wherein the neural network further comprises a decoder configured to restore the corresponding signal image using the extracted data, and
wherein the processor is configured to:
train the encoder and the decoder; and
for the training of the neural network, using the first trained encoder, train the classification header and the metadata header.

20. The electronic device of claim 19, wherein the processor is configured to:
generate first temporary output data by a decoder header of the decoder based on the extracted data, calculate a representation loss based on the calculated first temporary output data and the corresponding signal image, and perform the first training of only the encoder and the decoder based on the calculated representation loss.

21. The electronic device of claim 20, wherein, for the training of the neural network, the processor is configured to:
generate, dependent on another corresponding signal image being provided to the first trained encoder, second temporary output data by the classification header and third temporary output data by the metadata header, respectively;
generate a classification loss based on the second temporary output data and a previously classified label of the other corresponding signal image, and a metadata loss based on the third temporary output data and previously mapped metadata of the other corresponding signal image; and
train the neural network based on a total loss comprising the calculated representation loss, the calculated classification loss, and the calculated metadata loss.

22. The electronic device of claim 21, wherein, for the training of the neural network, the processor is configured to:
end the training of the neural network upon a first clustering score for first metadata calculated from the generated feature map exceeding a first threshold score and a second clustering score for a label calculated from the generated feature map exceeding a second threshold score, while the training of the neural network is being performed using the plurality of signal images as training data for the other corresponding signal image.
